(19) United States
(12) Patent Application Publication
(10) Pub. No.: US 2026/0158693 A1
(43) Pub. Date: Jun. 11, 2026

(54) PIPE CUTTER

(71) Applicant: ORIX ENTERPRISE CO., LTD., Taichung (TW)

(72) Inventor: Eric LIAO, Taichung (TW)

(21) Appl. No.: 19/368,587

(22) Filed: Oct. 24, 2025

(30) Foreign Application Priority Data
Dec. 10, 2024 (TW) 113147829

(51) Int. Cl. B26D 3/16; B26D 7/01; B26D 7/02

(52) U.S. Cl. CPC B26D 3/169; B26D 7/02; B26D 2007/013

(57) ABSTRACT

A pipe cutter comprises a main body, a clamping assembly and a cutting blade. The main body has a first gripping member and a second gripping member. The clamping assembly has a first clamping arm and a second clamping arm pivotally disposed side by side in the guide groove of the first gripping member, the first clamping arm and the second clamping arm being rotatable relative to each other under external force so as to vary a clamping angle therebetween. The cutting blade is fixed to the main body. A cutting space is defined between the cutting blade and the clamping assembly for receiving a pipe. Wherein when the cutting blade applies a force to the pipe located in the cutting space, the first clamping arm and the second clamping arm of the clamping assembly rotate toward each other so as to cooperatively clamp an outer surface of the pipe.

### BACKGROUND OF THE INVENTION

The present invention relates to a pipe cutter, and more particularly to a pipe cutter structure capable of stably clamping pipes of smaller sizes.

A pipe cutter, also known as a PVC pipe cutter, is a type of hand tool specifically designed for cutting plastic pipes such as PVC pipes and PPR pipes. It is widely used in plumbing engineering, construction work, and household maintenance. This tool generally consists of two handles and a cutting blade, wherein the blade is specially treated to ensure sharpness and durability. By pressing the handles, a user can drive the blade to cut through a pipe quickly and precisely. Compared with a traditional saw, the pipe cutter offers advantages such as ease of operation, high cutting efficiency, and smooth cutting surfaces, and is therefore widely adopted in pipe installation and repair operations.

Although a pipe cutter offers many advantages in daily use, certain problems still exist during its operation. The most common issue is that the pipe tends to slip during the cutting process. This problem may cause a deviation in the cutting position, thereby affecting both the cutting accuracy and the quality of the cut surface. The primary reason lies in that the design of most conventional pipe cutters relies mainly on the frictional force between the cutting edge and the pipe to hold the pipe in place. When the surface of the pipe is excessively smooth or when the pipe diameter is relatively large, the insufficient frictional force may result in slippage during cutting. On the other hand, some low-cost pipe cutters fail to provide adequate stability in the design of their blades and clamping portions, particularly when cutting pipes of higher hardness or smaller diameters, thus making it difficult to securely hold the pipe during operation.

Since the slippage of a pipe during cutting may cause inaccurate cutting positions, it often requires repeated operations or even results in scrapped pipes, thereby wasting materials and extending construction time. In addition, the slippage problem increases the risk of injury to the operator, especially when using high-pressure cutting tools. Therefore, how to provide a pipe cutter that can effectively solve the problem of pipe slippage has become one of the urgent issues to be addressed by professionals and researchers in the related field.

### SUMMARY OF THE INVENTION

In view of the above, the primary object of the present invention is to provide a pipe cutter, which can automatically clamp a pipe when the cutting blade cuts the pipe, thereby preventing the pipe from slipping.

In order to achieve the objective of the present invention, the present invention discloses that a pipe cutter comprises a main body, a clamping assembly and a cutting blade. The main body has a first gripping member and a second gripping member, wherein an end of the first gripping member is provided with a guide groove, and the second gripping member is pivotally connected to the first gripping member and has a blade-receiving slot at one end thereof. The clamping assembly has a first clamping arm and a second clamping arm pivotally disposed side by side in the guide groove of the first gripping member, the first clamping arm and the second clamping arm being rotatable relative to each other under an external force so as to vary a clamping angle therebetween. The cutting blade is fixed to the main body within the blade-receiving slot of the second gripping member, the cutting blade having a cutting edge extending outward from the blade-receiving slot and corresponding to the clamping assembly, the cutting blade being configured to move synchronously with the second gripping member toward or away from the clamping assembly. A cutting space is defined between the cutting blade and the clamping assembly for receiving a pipe. Wherein when the cutting blade applies a force to the pipe located in the cutting space, the first clamping arm and the second clamping arm of the clamping assembly rotate toward each other so as to cooperatively clamp an outer surface of the pipe.

In an embodiment, the first clamping arm has a first arcuate surface in the cutting space, and the second clamping arm has a second arcuate surface in the cutting space, such that when the first clamping arm and the second clamping arm rotate toward each other, the first arcuate surface and the second arcuate surface respectively clamp an outer surface of the pipe.

In an embodiment, one side of the first clamping arm adjacent to the second clamping arm is provided with a first engaging portion having at least one first engaging tooth and at least one first engaging groove alternately arranged, and one side of the second clamping arm adjacent to the first clamping arm is provided with a second engaging portion corresponding to the first engaging portion, the second engaging portion having at least one second engaging tooth and at least one second engaging groove alternately arranged.

In an embodiment, when the first clamping arm and the second clamping arm rotate toward each other, at least one of the first engaging teeth of the first engaging portion engages with at least one of the second engaging grooves of the second engaging portion, and at least one of the second engaging teeth of the second engaging portion engages with at least one of the first engaging grooves of the first engaging portion.

In an embodiment, a bottom side of the first clamping arm has a first abutting surface, and a bottom side of the second clamping arm has a second abutting surface, such that, in a normal state, the first abutting surface of the first clamping arm and the second abutting surface of the second clamping arm abut against a bottom surface of the guide groove, and when the first clamping arm and the second clamping arm rotate toward each other, the first abutting surface of the first clamping arm and the second abutting surface of the second clamping arm move away from the bottom surface of the guide groove.

In an embodiment, the clamping assembly further includes an elastic member having one end abutting against the first gripping member and another end abutting against the first clamping arm, the elastic member being configured to bias the first clamping arm and the second clamping arm to rotate away from each other.

In an embodiment, the first gripping member further has a resilient slot at a bottom portion of the guide groove for allowing one end of the elastic member to abut thereagainst.

In an embodiment, further comprising a positioning member movably connected between the first gripping member and the second gripping member and configured to be operated to rotate between a first angle and a second angle, wherein when the positioning member is located at the first angle, the positioning member connects the first gripping member and the second gripping member to restrict relative movement therebetween, and when the positioning member is located at the second angle, the positioning member is disengaged from the second gripping member, allowing the second gripping member to move relative to the first gripping member.

In an embodiment, the first gripping member has a lever slot, the second gripping member has a hook slot communicated with the lever slot, and the positioning member includes a lever portion and a hook portion, the lever portion being pivotally disposed in the lever slot of the first gripping member, and the hook portion being connected to one end of the lever portion and corresponding to the hook slot of the second gripping member, such that when the positioning member is located at the first angle, the hook portion of the positioning member engages with the hook slot of the second gripping member, and when the positioning member is located at the second angle, the hook portion of the positioning member disengages from the hook slot of the second gripping member.

In an embodiment, the positioning member further includes a detent assembly disposed in a detent hole of the lever portion, the detent assembly comprising a protruding post, a detent spring, and a ball, the protruding post and the ball being respectively disposed at opposite sides of the detent hole, and the detent spring being disposed between the protruding post and the ball with one end acting on the ball such that, when the positioning member is located at the first angle, the ball abuts against a circular groove formed on a side surface of the lever slot.

A preferred embodiment is described hereafter, accompanied with drawings, according to the objective and function of the present invention.

### BRIEF DESCRIPTION OF DRAWINGS

FIG. 1 is a perspective view of a first preferred embodiment of the present invention;

FIG. 2 is an exploded view of the first preferred embodiment of the present invention;

FIG. 3 is a partial sectional view of the first preferred embodiment of the present invention, showing the clamping assembly in the normal state;

FIG. 4 is a partial sectional view of the first preferred embodiment of the present invention, showing the clamping assembly is forced to clamp the pipe;

FIG. 5 is a sectional view of the first preferred embodiment of the present invention, showing the positioning member in the first angle;

FIG. 6 is a perspective view of the first preferred embodiment of the present invention, showing the positioning member in the second angle;

FIG. 7 is a perspective view of a second preferred embodiment of the present invention; and

FIG. 8 is a sectional view of the second preferred embodiment of the present invention.

### DETAILED DESCRIPTION OF THE INVENTION

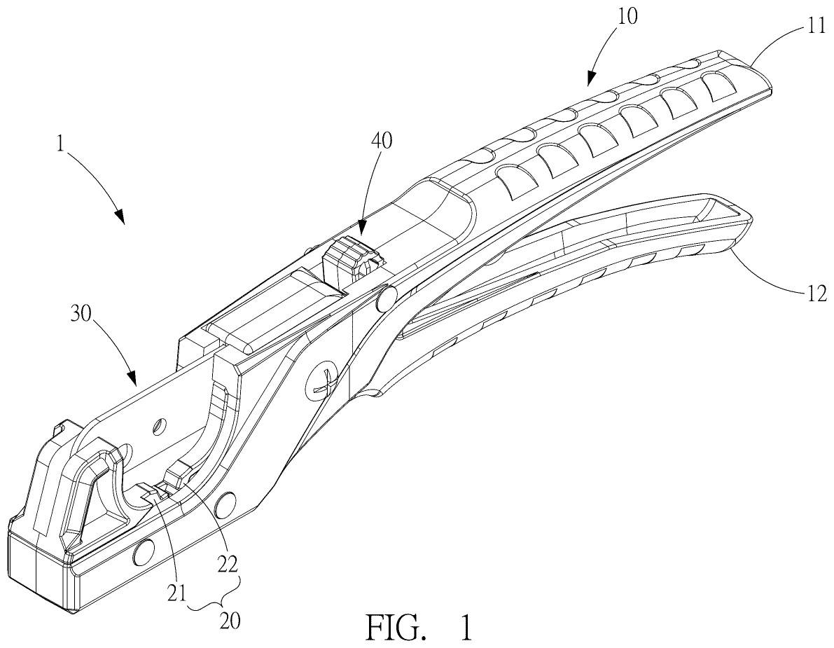

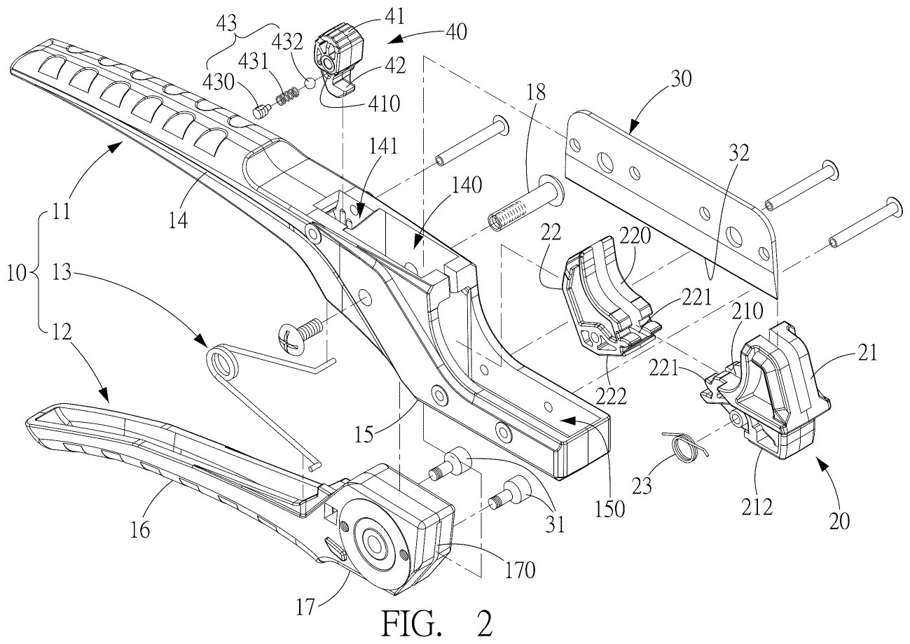

As shown in FIG. 1 to FIG. 2, a pipe cutter 1 of the first preferred embodiment of the present invention mainly includes a main body 10, a clamping assembly 20, and a cutting blade 30.

The main body 10 includes a first gripping member 11, a second gripping member 12, and a spring 13. The first gripping member 11 and the second gripping member 12 are disposed opposite to each other. The first gripping member 11 has a first handle 14 and a first mounting portion 15. The first handle 14 is formed with a pivot slot 140. The first mounting portion 15 is located at one end of the first handle 14, generally formed in an arcuate shape, and has a guide groove 150 that extends arcuately at its center. The guide groove 150 is in communication with the pivot slot 140.

The second gripping member 12 includes a second handle 16 and a second mounting portion 17. The second mounting portion 17 is located at one end of the second handle 16 and is pivotally connected to the pivot slot 140 of the first gripping member 11 through a pivot shaft 18. A blade-receiving slot 170 is formed at the center of the second mounting portion 17 for receiving the cutting blade 30.

The spring 13 is disposed between the first gripping member 11 and the second gripping member 12. Two ends of the spring 13 respectively act on the first handle 14 of the first gripping member 11 and the second handle 16 of the second gripping member 12, so that the first handle 14 of the first gripping member 11 and the second handle 16 of the second gripping member 12 tend to rotate away from each other under a normal state.

The clamping assembly 20 is disposed in the guide groove 150 of the first gripping member 11 and is configured to receive and clamp a pipe. Specifically, the clamping assembly 20 includes a first clamping arm 21, a second clamping arm 22, and an elastic member 23. The first clamping arm 21 and the second clamping arm 22 are pivotally mounted side by side in the guide groove 150 of the first gripping member 11 in a rotatable manner, and the first clamping arm 21 is positioned farther from the first handle 14 than the second clamping arm 22.

The first clamping arm 21 has a first arcuate surface 210, a first engaging portion 211, and a first abutting surface 212. The second clamping arm 22 has a second arcuate surface 220, a second engaging portion 221, and a second abutting surface 222. The first arcuate surface 210 of the first clamping arm 21 and the second arcuate surface 220 of the second clamping arm 22 are disposed opposite to each other.

The first engaging portion 211 is formed on one side of the first clamping arm 21 adjacent to the second clamping arm 22 and includes a plurality of first engaging teeth 211a and a plurality of first engaging grooves 211b. The second engaging portion 221 is formed on one side of the second clamping arm 22 adjacent to the first clamping arm 21 and includes a plurality of second engaging teeth 221a and a plurality of second engaging grooves 221b.

In a normal state, one of the first engaging teeth 211a of the first engaging portion 211 engages with one of the second engaging grooves 221b of the second engaging portion 221, and one of the second engaging teeth 221a engages with one of the first engaging grooves 211b. When the first clamping arm 21 and the second clamping arm 22 rotate relative to each other, the first engaging teeth 211a engage with the second engaging grooves 221b, and the second engaging teeth 221a engage with the first engaging grooves 211b. The first engaging portion 211 and the second engaging portion 221 are configured to reduce interference generated during the rotation of the first clamping arm 21 and the second clamping arm 22.

The first abutting surface 212 is located at a bottom side of the first clamping arm 21, and the second abutting surface 222 is located at a bottom side of the second clamping arm 22. In a normal state, the first abutting surface 212 of the first clamping arm 21 and the second abutting surface 222 of the second clamping arm 22 abut against a bottom surface of the guide groove 150. When the first clamping arm 21 and the second clamping arm 22 rotate toward each other, the first abutting surface 212 and the second abutting surface 222 move away from the bottom surface of the guide groove 150.

The elastic member 23 has one end abutting against the first gripping member 11 and another end abutting against the first clamping arm 21, so as to bias the first clamping arm 21 and the second clamping arm 22 to rotate away from each other. A resilient slot 151 is further formed at a bottom portion of the guide groove 150 of the first mounting portion 15 of the first gripping member 11 for receiving one end of the elastic member 23.

The cutting blade 30 is a metal plate mounted in the blade-receiving slot 170 of the second gripping member 12 and is secured to the second gripping member 12 by at least one fastener 31, such that the cutting blade 30 moves synchronously with the second gripping member 12. One end of the cutting blade 30 is formed with a cutting edge 32, which extends outward from the blade-receiving slot 170 and corresponds to the clamping assembly 20. A cutting space 33 is defined between the clamping assembly 20 and the cutting blade 30 for receiving a pipe. When a user presses the first gripping member 11 and the second gripping member 12 toward each other, the cutting blade 30 moves together with the second gripping member 12 toward the clamping assembly 20 to cut the pipe located in the cutting space 33.

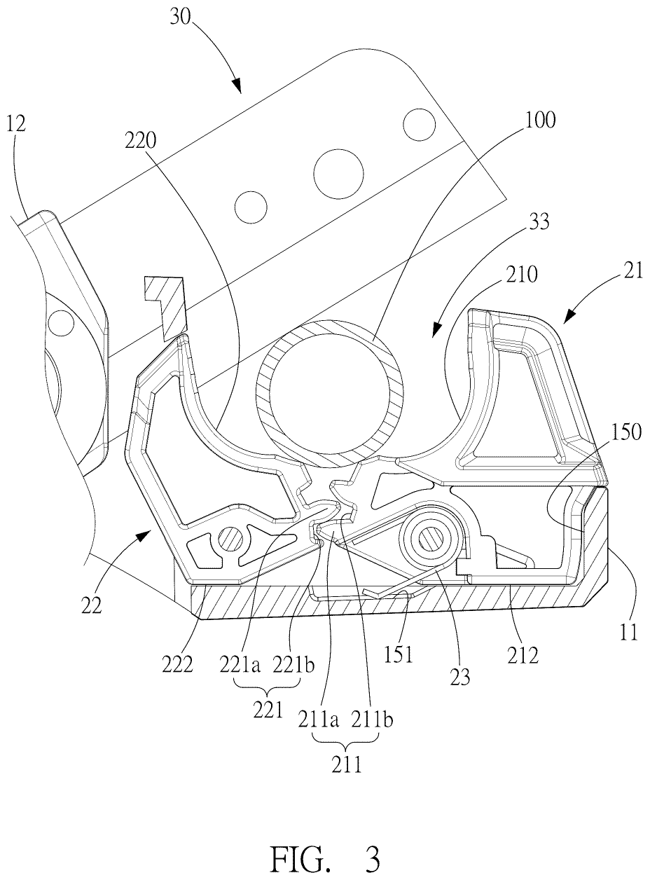

As shown in FIG. 3, when a user places a pipe 100 into the cutting space 33 of the pipe cutter 1 before performing a cutting operation, the cutting blade 30 has not yet come into contact with the pipe 100. At this moment, since no external force is applied to the clamping assembly 20, the first abutting surface 212 of the first clamping arm 21 and the second abutting surface 222 of the second clamping arm 22 remain in contact with the bottom of the guide groove 150, such that the first arcuate surface 210 and the second arcuate surface 220 are spaced apart from each other, and the pipe 100 rests above the first engaging portion 211 and the second engaging portion 221.

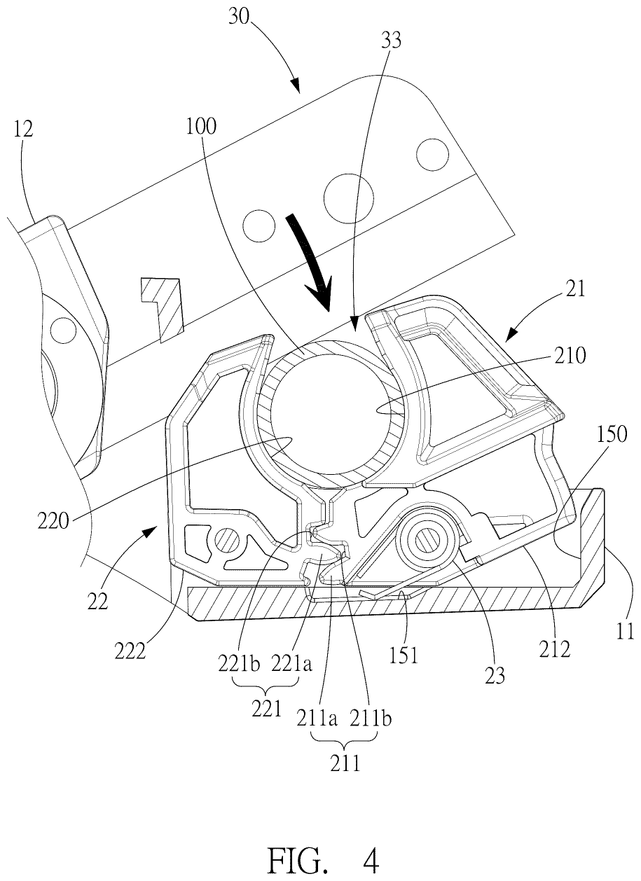

Next, please refer to FIG. 4. When the user presses the first gripping member 11 and the second gripping member 12, the cutting blade 30 moves together with the second gripping member 12 toward the clamping assembly 20 to cut the pipe 100 located in the cutting space 33.

It should be noted that since the pipe cutter 1 of the present embodiment is provided with the clamping assembly 20, when the clamping assembly 20 is subjected to pressure from the pipe 100, the first clamping arm 21 and the second clamping arm 22 rotate toward each other, causing the first arcuate surface 210 and the second arcuate surface 220 to clamp the pipe 100 securely.

Accordingly, the pipe 100 is prevented from sliding relative to the pipe cutter 1 during the cutting operation, thereby effectively enhancing the safety and efficiency of the cutting process. After the pipe 100 is completely cut, as the clamping assembly 20 is no longer under pressure, the first clamping arm 21 and the second clamping arm 22 automatically rotate away from each other under the restoring force of the elastic member 23 until they return to their original positions.

It should be particularly noted that, for a pipe of a larger diameter, the first clamping arm 21 and the second clamping arm 22 only need to rotate inwardly by a small angle (corresponding to a smaller force applied by the cutting blade 30) to clamp the pipe. On the other hand, for a pipe of a smaller diameter, the first clamping arm 21 and the second clamping arm 22 can rotate inwardly by a larger angle (corresponding to a greater force applied by the cutting blade 30) to securely clamp the pipe as well. In other words, due to the structural design of the first clamping arm 21 and the second clamping arm 22, the pipe cutter 1 of the present invention is applicable to pipes of various sizes.

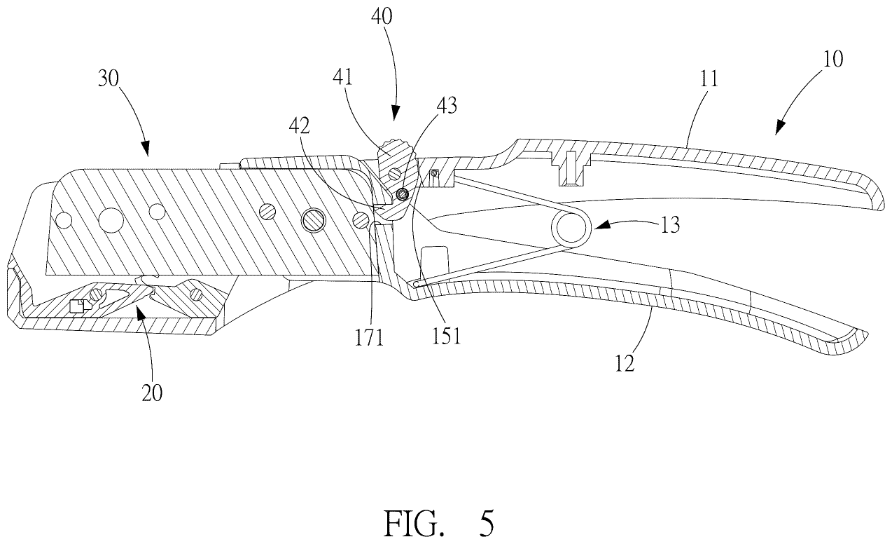

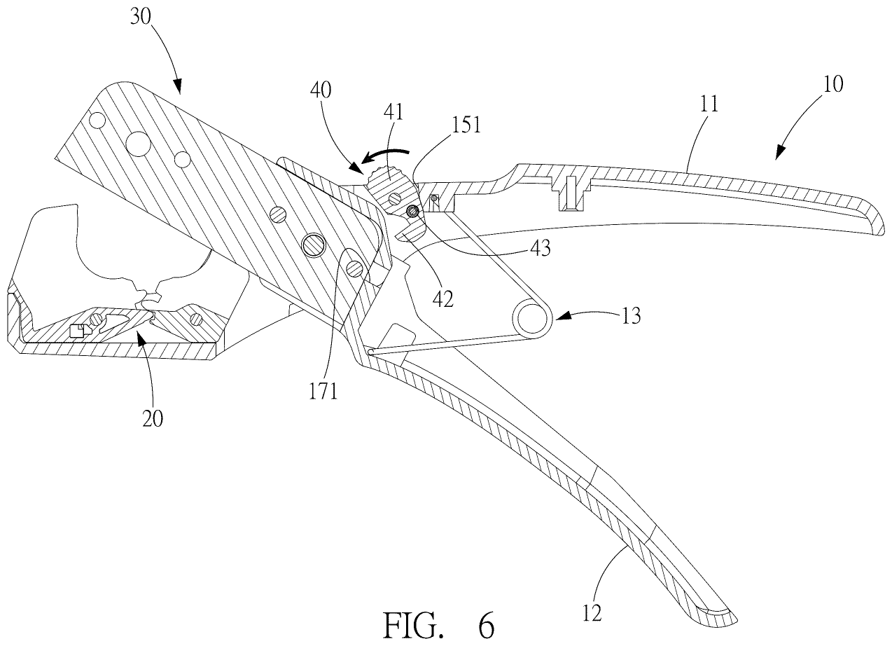

As shown in FIG. 5 and FIG. 6, the pipe cutter 1 of the present embodiment further includes a positioning member 40, which is movably connected between the first gripping member 11 and the second gripping member 12 and is configured to rotate between a first angle and a second angle by operation. When the positioning member 40 is located at the first angle, the positioning member 40 connects the first gripping member 11 and the second gripping member 12 to restrict relative movement therebetween. When the positioning member 40 is located at the second angle, the positioning member 40 is disengaged from the second gripping member 12, thereby allowing the second gripping member 12 to move relative to the first gripping member 11.

Specifically, the positioning member 40 includes a lever portion 41 and a hook portion 42. The lever portion 41 is pivotally mounted in a lever slot 141 of the first handle 14 of the first gripping member 11. The hook portion 42 is integrally connected to one end of the lever portion 41 and corresponds to a hook slot 171 formed in the second handle 16 of the second gripping member 12. When the positioning member 40 is located at the first angle, the hook portion 42 of the positioning member 40 engages with the hook slot 171 of the second gripping member 12. When the positioning member 40 is rotated to the second angle, the hook portion 42 of the positioning member 40 disengages from the hook slot 171 of the second gripping member 12.

Accordingly, when the user does not need to use the pipe cutter 1, the user can press the first gripping member 11 and the second gripping member 12 together and rotate the positioning member 40 to the first angle, whereby the positioning member 40 automatically locks the first gripping member 11 and the second gripping member 12 to prevent them from opening. When the user intends to use the pipe cutter 1, the positioning member 40 can be rotated to the second angle, allowing the first gripping member 11 and the second gripping member 12 to open automatically under the biasing force of the spring 13, thereby enabling subsequent pipe-cutting operations.

It should be further noted that the positioning member 40 also includes a detent assembly 43, which is disposed in a detent hole 410 of the lever portion 41. The detent assembly 43 includes a protruding post 430, a detent spring 431, and a ball 432. The protruding post 430 and the ball 432 are respectively disposed at opposite ends of the detent hole 410, and the ball 432 abuts against a circular groove (not shown) formed on a sidewall of the lever slot 141. The detent spring 431 is positioned between the protruding post 430 and the ball 432, with two ends respectively acting on the protruding post 430 and the ball 432 to urge the ball 432 against the circular groove.

The detent assembly 43 serves to enhance the engagement strength of the positioning member 40 when located at the first angle, providing positional retention by allowing the ball 432 to engage with the circular groove under normal conditions. When the user operates the positioning member 40 and applies force to the ball 432, the ball 432 is disengaged from the circular groove, allowing the positioning member 40 to rotate from the first angle to the second angle. Therefore, when the first gripping member 11 and the second gripping member 12 are locked by the positioning member 40, they will not be unintentionally separated due to accidental contact.

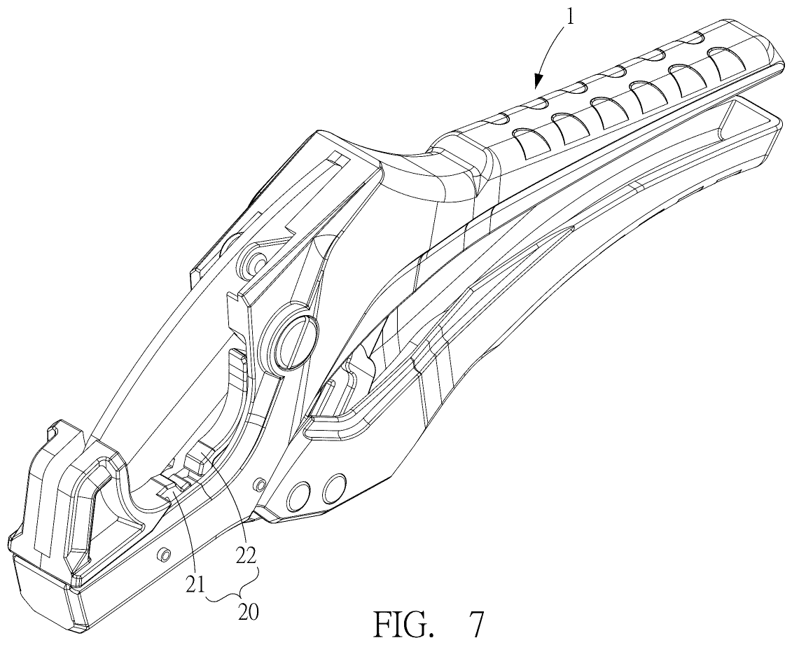

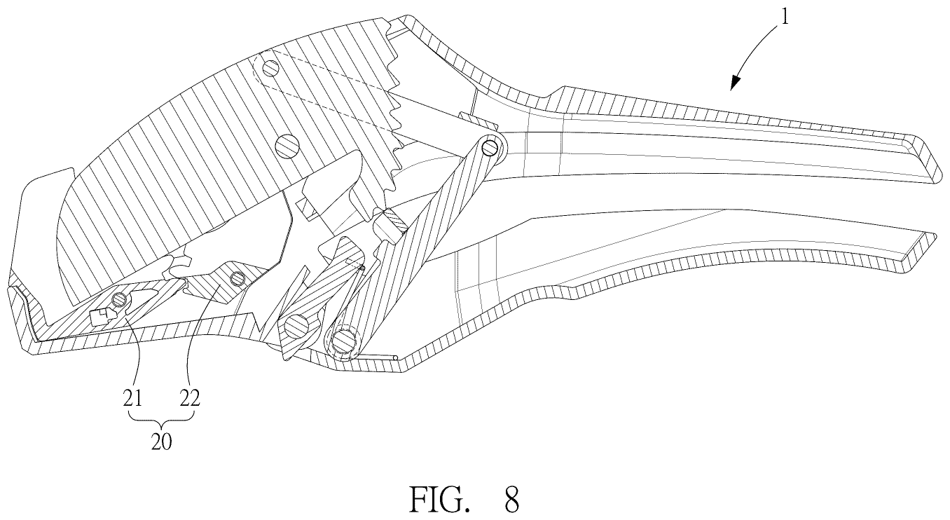

It should be particularly noted that although, in the present embodiment, the clamping assembly 20 is disclosed as being applied to a pipe cutter without a ratchet-type cutting mechanism, the present invention is not limited thereto. In a second preferred embodiment, the clamping assembly 20 may also be applied to a pipe cutter having a ratchet-type cutting mechanism, as illustrated in FIG. 7 and FIG. 8. Although the operating principle of the cutting blade may differ slightly, the first clamping arm 21 and the second clamping arm 22 of the clamping assembly 20 can still achieve the function of securely clamping the pipe and preventing it from slipping. In other words, any pipe cutter configured with the clamping assembly 20 disclosed in the present invention falls within the scope of application of the invention.

In summary, the pipe cutter provided by the present invention, through the first clamping arm and the second clamping arm of the clamping assembly, can automatically clamp a pipe when the cutting blade cuts the pipe, thereby preventing the pipe from slipping. Accordingly, the present invention can provide a safer and more efficient pipe-cutting operation.

It must be pointed out that the embodiments described above are only some preferred embodiments of the present invention. All equivalent structures which employ the concepts disclosed in this specification and the appended claims should fall within the scope of the present invention.

1. A pipe cutter, comprising:
a main body having a first gripping member and a second gripping member, wherein an end of the first gripping member is provided with a guide groove, and the second gripping member is pivotally connected to the first gripping member and has a blade-receiving slot at one end thereof;
a clamping assembly having a first clamping arm and a second clamping arm pivotally disposed side by side in the guide groove of the first gripping member, the first clamping arm and the second clamping arm being rotatable relative to each other under an external force so as to vary a clamping angle therebetween; and
a cutting blade fixed to the main body within the blade-receiving slot of the second gripping member, the cutting blade having a cutting edge extending outward from the blade-receiving slot and corresponding to the clamping assembly, the cutting blade being configured to move synchronously with the second gripping member toward or away from the clamping assembly; wherein a cutting space is defined between the cutting blade and the clamping assembly for receiving a pipe;
Wherein when the cutting blade applies a force to the pipe located in the cutting space, the first clamping arm and the second clamping arm of the clamping assembly rotate toward each other so as to cooperatively clamp an outer surface of the pipe.

2. The pipe cutter of claim 1, wherein the first clamping arm has a first arcuate surface in the cutting space, and the second clamping arm has a second arcuate surface in the cutting space, such that when the first clamping arm and the second clamping arm rotate toward each other, the first arcuate surface and the second arcuate surface respectively clamp an outer surface of the pipe.

3. The pipe cutter of claim 1, wherein one side of the first clamping arm adjacent to the second clamping arm is provided with a first engaging portion having at least one first engaging tooth and at least one first engaging groove alternately arranged, and one side of the second clamping arm adjacent to the first clamping arm is provided with a second engaging portion corresponding to the first engaging portion, the second engaging portion having at least one second engaging tooth and at least one second engaging groove alternately arranged.

4. The pipe cutter of claim 3, wherein when the first clamping arm and the second clamping arm rotate toward each other, at least one of the first engaging teeth of the first engaging portion engages with at least one of the second engaging grooves of the second engaging portion, and at least one of the second engaging teeth of the second engaging portion engages with at least one of the first engaging grooves of the first engaging portion.

5. The pipe cutter of claim 1, wherein a bottom side of the first clamping arm has a first abutting surface, and a bottom side of the second clamping arm has a second abutting surface, such that, in a normal state, the first abutting surface of the first clamping arm and the second abutting surface of the second clamping arm abut against a bottom surface of the guide groove, and when the first clamping arm and the second clamping arm rotate toward each other, the first abutting surface of the first clamping arm and the second abutting surface of the second clamping arm move away from the bottom surface of the guide groove.

6. The pipe cutter of claim 1, wherein the clamping assembly further includes an elastic member having one end abutting against the first gripping member and another end abutting against the first clamping arm, the elastic member being configured to bias the first clamping arm and the second clamping arm to rotate away from each other.

7. The pipe cutter of claim 6, wherein the first gripping member further has a resilient slot at a bottom portion of the guide groove for allowing one end of the elastic member to abut thereagainst.

8. The pipe cutter of claim 1, further comprising a positioning member movably connected between the first gripping member and the second gripping member and configured to be operated to rotate between a first angle and a second angle, wherein when the positioning member is located at the first angle, the positioning member connects the first gripping member and the second gripping member to restrict relative movement therebetween, and when the positioning member is located at the second angle, the positioning member is disengaged from the second gripping member, allowing the second gripping member to move relative to the first gripping member.

9. The pipe cutter of claim 8, wherein the first gripping member has a lever slot, the second gripping member has a hook slot communicated with the lever slot, and the positioning member includes a lever portion and a hook portion, the lever portion being pivotally disposed in the lever slot of the first gripping member, and the hook portion being connected to one end of the lever portion and corresponding to the hook slot of the second gripping member, such that when the positioning member is located at the first angle, the hook portion of the positioning member engages with the hook slot of the second gripping member, and when the positioning member is located at the second angle, the hook portion of the positioning member disengages from the hook slot of the second gripping member.

10. The pipe cutter of claim 9, wherein the positioning member further includes a detent assembly disposed in a detent hole of the lever portion, the detent assembly comprising a protruding post, a detent spring, and a ball, the protruding post and the ball being respectively disposed at opposite sides of the detent hole, and the detent spring being disposed between the protruding post and the ball with one end acting on the ball such that, when the positioning member is located at the first angle, the ball abuts against a circular groove formed on a side surface of the lever slot.
